(19) United States
(12) Patent Application Publication
(10) Pub. No.: US 2021/0147751 A1
(43) Pub. Date: May 20, 2021

(54) BIOREJUVENATORS

(71) Applicants: Elham Fini, Phoenix, AZ (US); Shuguang Deng, Mesa, AZ (US)

(72) Inventors: Elham Fini, Phoenix, AZ (US); Shuguang Deng, Mesa, AZ (US)

(21) Appl. No.: 16/953,548

(22) Filed: Nov. 20, 2020

Related U.S. Application Data
(60) Provisional application No. 62/938,104, filed on Nov. 20, 2019.

(51) Int. Cl. C10G 1/00; C08L 95/00; E01C 7/18

(52) U.S. Cl. CPC C10G 1/00; C08L 95/00; C10G 2300/1018; C08L 2555/64; E01C 7/187

(57) ABSTRACT

A biorejuvenator includes a bio-oil formed from a mixture including a first biomass component and a second biomass component. A nitrogen content of the first biomass component exceeds a nitrogen content of the second biomass component, and a lipid content of the second biomass component exceeds a lipid content of the first biomass component. Preparing the biorejuvenator includes combining a first biomass component and a second biomass component, and co-liquefying the first biomass component and the second biomass component to yield the biorejuvenator. The biorejuvenator can be used as an asphalt modifier in an asphalt composition or as a coating for asphalt pavement.

### CROSS-REFERENCE TO RELATED APPLICATION

This application claims the benefit of U.S. Patent Application No. 62/938,104 entitled “ASPHALT MODIFIERS” and filed on Nov. 20, 2019, which is incorporated by reference herein in its entirety.

### STATEMENT OF GOVERNMENT SUPPORT

This invention was made with government support under 1928807 and 1928795 awarded by the National Science Foundation. The government has certain rights in the invention.

### TECHNICAL FIELD

This invention relates to biorejuvenators with anti-agglomerating and anti-moisture properties suitable for restoring chemical balance of oxidized asphalt, and methods of making these biorejuvenators.

### BACKGROUND

Using reclaimed asphalt pavement in the construction of new pavement reduces the consumption of fresh petroleum bitumen. Bitumen is a mixture of fragments with organic origin that are subject to oxidative aging when exposed to atmospheric oxygen during the service life of the pavement. This oxidative aging causes chemical changes that lead to reductions in toughness and compliance. The aging level of asphalt varies based at least in part on environmental conditions, service life, and initial molecular composition.

### SUMMARY

Revitalizing reclaimed asphalt pavement can enhance its durability and facilitate resource conservation while promoting upcycling instead of downcycling. True revitalization requires restoring not only chemical balance but also molecular conformation. Therefore, rejuvenators should be able to de-agglomerate oxidized asphaltenes while compensating for components that are lost during aging. As described in this disclosure, balanced feedstock can be used to control composition and concentration of active molecules in a biorejuvenator to increase its efficiency. Combinations of high protein feedstock (e.g., algae) and high lipid feedstock (e.g., manure) can be used to synthesize biorejuvenators having different concentrations of alkane chains and fused aromatics, with the former helping to restore chemical balance and the latter working to de-agglomerate oxidized asphaltene. This in turn can restore aged bitumen molecular conformation leading to restoration of its physio-chemical and rheological properties.

In a first general aspect, a biorejuvenator includes a bio-oil formed from a mixture including a first biomass component and a second biomass component. A nitrogen content of the first biomass component exceeds a nitrogen content of the second biomass component, and a lipid content of the second biomass component exceeds a lipid content of the first biomass component.

Implementations of the first general aspect may include one or more of the following features.

In some cases, the first biomass component is liquefied, and the second biomass component is liquefied. In certain cases, the first biomass component and the second biomass component are co-liquefied. A dry weight ratio of the first biomass component to the second biomass component is typically in a range of about 6:1 to about 2:1 (e.g., about 4:1). In one example, the first biomass component includes algae and the second biomass component includes swine manure.

In a second general aspect, an asphalt composition includes asphalt and the biorejuvenator of the first general aspect. A weight ratio of the asphalt to the biorejuvenator can be in a range of about 5:1 to about 20:1. The asphalt can be reclaimed asphalt pavement.

In a third general aspect, a coated asphalt includes an asphalt substrate and a coating of the biorejuvenator of the first general aspect on the asphalt substrate.

In a fourth general aspect, preparing a biorejuvenator includes combining a first biomass component and a second biomass component, and co-liquefying the first biomass component and the second biomass component to yield the biorejuvenator. A nitrogen content of the first biomass component exceeds a nitrogen content of the second biomass component, and a lipid content of the second biomass component exceeds a lipid content of the first biomass component.

Implementations of the fourth general aspect may include one or more of the following features.

A dry weight ratio of the first biomass component to the second biomass component is typically in a range of about 6:1 to about 2:1 (e.g., about 4:1). In some cases, the first biomass component includes algae, the second biomass component comprises swine manure, or both. Co-liquefying can include hydrothermally liquefying. The fourth general aspect may further include combining the biorejuvenator with asphalt (e.g., reclaimed asphalt pavement). The fourth general aspect may also further include coating an asphalt surface with the biorejuvenator. In one example, the biorejuvenator is a bio-oil.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1F show storage modulus (G′) and loss modulus (G″) for aged asphalt before and after introducing biorejuvenators made from different ratios of algae and swine manure.

### DETAILED DESCRIPTION

Bitumen in asphalt pavement is subject to oxidative aging over time, which makes it stiff and prone to cracking. Oxidative aging happens when the asphalt pavement is exposed to atmospheric oxygen. Reactive molecules in bitumen (such as asphaltene molecules) can react with oxygen which increases the polarity of molecules. This phenomenon increases interaction between bitumen components and makes asphalt harder and more brittle, increasing the risk of premature cracking. One consequence of irreversible oxidation is an increase in viscosity of bitumen that is due at least in part to two mechanisms: i) evaporation of light components in bitumen and the reduction of maltene/asphaltene ratio during short term and long-term aging, and ii) oxidation of highly reactive molecules, which leads to a change in functional group composition and increases the concentration of polar components.

During oxidative aging, the increase in polarity of bitumen components increases interaction between bitumen molecules and causes agglomeration. This increase in interactions is thought to be due to an increase in forces such as hydrogen bonding, van der Waals forces, and coulombic interactions. One intermolecular interaction in bitumen is π-π interaction between polycyclic fused aromatic molecules mostly known as asphaltenes. Interactions further increase when the polarity of asphaltene molecules increases, typically causing agglomeration of asphaltene molecules which in turn leads to formation of nano-aggregates. Aggregation has been implicated in undesirable high stiffness and brittleness of aged asphalt. To restore the properties of aged bitumen, different modifiers (“rejuvenators”) can be used to revitalize aged bitumen.

This disclosure describes a biorejuvenator for revitalizing aged bitumen. As used herein, “biorejuvenator” generally refers to a bio-oil selected to restore chemical components lost from asphalt during aging and to de-agglomerate oxidize asphaltenes. The biorejuvenator can restore the molecular conformation of aged bitumen and restore its physico-chemical and rheological properties. As used herein, “bio-oil” generally refers an oil derived from pyrolysis of biomass. The biorejuvenator includes a bio-oil formed from mixture including a first biomass component and a second biomass component. The first and second biomass components are selected such that a nitrogen content of the first biomass component exceeds a nitrogen content of the second biomass component, and a lipid content of the second biomass component exceeds a lipid content of the first biomass component. Examples described in this disclosure refer to the first biomass component as algae and the second biomass component as swine manure. However, other biomass components are also suitable.

The first biomass component and the second biomass component of the bio-oil are liquefied. In some cases, the first biomass component and the second biomass component are co-liquefied. A dry weight ratio of the first biomass component to the second biomass component is typically in a range of about 6:1 to about 2:1. In one example, the dry weight ratio of the first biomass component to the second biomass component is about 4:1.

The biorejuvenator can be combined with asphalt to yield an asphalt composition. In some cases, a weight ratio of the asphalt to the biorejuvenator is in a range of about 5:1 to about 20:1. At least some of the asphalt in the asphalt composition can be previously used (e.g., reclaimed or recycled). Asphalt (e.g., asphalt pavement) can be coated with the biorejuvenator to yield a coated asphalt composition. The biorejuvenator coating can extend the lifetime of the asphalt.

Preparing the biorejuvenator includes combining a first biomass component and a second biomass component, and co-liquefying the first biomass component and the second biomass component to yield the biorejuvenator. In one example, co-liquefying includes hydrothermally liquefying a mixture of the first biomass component and the second biomass component.

A nitrogen content of the first biomass component exceeds a nitrogen content of the second biomass component, and a lipid content of the second biomass component exceeds a lipid content of the first biomass component. A dry weight ratio of the first biomass component to the second biomass component is typically in a range of about 6:1 to about 2:1. In one example, a dry weight ratio of the first biomass component to the second biomass component is about 4:1, the first biomass component includes algae, and the second biomass component includes manure (e.g., swine manure).

The biorejuvenator can be combined with asphalt. The asphalt can include recycled or reclaimed asphalt. In some cases, an asphalt surface (e.g., an asphalt road) is coated with the biorejuvenator or a composition including the biorejuvenator.

As described in this disclosure, a biorejuvenator with highly active components is formed from a feedstock including a high lipid biomass and a high protein (high nitrogen) biomass. One example of a high lipid biomass is swine manure. One example of high protein biomass is algae. A feedstock including a selected ratio of algae and swine manure is liquefied and fractionated to yield a biorejuvenator that can be added to an aged bitumen, providing benefits of a rejuvenator and an anti-moisture additive for asphalt pavement. A suitable weight ratio of high protein biomass to high lipid biomass is in a range of about 6:1 to about 2:1 (e.g., about 4:1).

In one example, a biorejuvenator is made from hydrothermal co-liquefaction of swine manure and algae biomass. The combination of the two sources yields an effective modifier by contributing adequate fatty acids and lipids coming from algae and swine manure, respectively. The modifier can increase durability and extend the life of pavements. The modifier can restore some of the properties of asphalt lost during its aging while enhancing binding of asphalt and stone aggregate to better resist damage caused by water and UV exposure, thereby increasing the durability and extend the life of pavement.

The two different feedstocks of biomass are taken as raw and co-liquefied to produce the biorejuvenator. The conversion of the biomass to bio-oils is achieved with hydrothermal liquefaction process. The resulting biorejuvenator is a durable, environmentally friendly and low-cost modifier for use in asphalt pavements to restore pavement properties that are lost during aging and service life, and to increase pavement resistance to moisture damage by passivating active sites on siliceous stones. It can be used as a spray sealant and slurry seal on top of an existing pavement surface, as a partial replacement (10-20% wt % of binder or 0.5-1 wt % by weight of the sealant).

The biorejuvenator can be used as a superplasticizer to reduce a water/cement ratio to enhance concrete strength. It can also be used to rejuvenate old asphalt pavements to extend their life and/or allow the use of high percentages of reclaimed asphalt pavement to be used in new paving compositions. The balanced feedstock contains high lipid (swine manure) and high nitrogen (algae) bio-mass. The resulting modifier has a high dosage efficiency at least in part because its composition is optimized to include molecules that can both intercalate into aged asphalt and reduce the size of its agglomerates. It has low polarizability, which helps enhance the resistance of the asphalt to moisture.

The biorejuvenator can facilitate the usage of reclaimed asphalt pavement (RAP) in new paving mixtures without compromising performance. Considering that RAP costs less than virgin aggregates, this provides additional incentive to asphalt contractors while reducing pavement carbon footprint and promoting resource conservation, as the supply of quality stone aggregates diminishes and piles of RAP are increasing as pavement milling and resurfacing continue. In addition, the use of the biorejuvenator as a spray sealant on the milled surface of an existing pavement may enhance binding with a new layer to increase the durability and longevity of the pavement.

The production of biorejuvenator from swine manure occurs using hydrothermal liquefaction process (HTL) at high pressure and high temperature to transform the organic compounds into liquid bio-oil and some side products such as char and different gases. Introduction of biorejuvenator from swine manure to aged bitumen can alter the molecular structure of aged bitumen and reduce the size of agglomerated oxidized asphaltenes and can improve chemical and rheological properties of aged asphalt. Biorejuvenator from swine manure contains certain nitrogen-carrying compounds (mostly amides and amines), which can effectively decrease the size of nano-aggregates of oxidized asphaltene molecules and increase resistance to moisture susceptibility of bitumen. Octadecanamide and hexadecenoic acid found in swine manure biorejuvenator can promote deagglomeration of oxidized asphaltene dimers.

The biorejuvenator obtained by liquefaction of a feedstock containing a 2:1 to 6:1 (e.g., 4:1) weight ratio of algae and manure yields a high dosage efficiency, restoring aged asphalt effectively. This effectiveness is attributed at least in part to a balanced combination of molecules which are effective intercalants and those which can de-agglomerate self-aggregated asphaltenes. These biorejuvenator molecules have a peptizing effect on oxidized asphaltene molecules, leading to a decrease in radial distribution function of oxidized asphaltene molecules in heptane medium. This in turn indicates the biorejuvenator contains highly active molecules which can enter asphaltene nano-aggregate and help de-agglomerate them or break them into smaller nano-aggregates. The abovementioned reduction in average nano-aggregate size is reflected in an increase in crossover modulus and crossover frequency. This is further evidenced by saturates, asphaltenes, resins, and aromatics (SARA) fractionation of each scenario, showing that biorejuvenators as disclosed herein help restore the colloidal balance of aged bitumen by supplying components lost during aging.

### Examples

### Materials Preparation

Preparation of Biorejuvenator.

The HTL performance of two different biomasses under similar conditions were studied. Galdieria sulphuraria (G. sulphuraria CCMEE 5587.1), an acido-thermophillic unicellular red alga species obtained from Culture Collection of Microorganisms from Extreme Environments (Pacific Northwest National Laboratory, Richland, U.S.A) was scaled up and grown at Arizona Center for Algae Technology and Innovation (AzCATI), Arizona State University. The harvested algae biomass (˜30% solids) were stored under 4° C. before used for experimentation and analysis. The swine manure used for HTL process was acquired from North Carolina farms. The swine manure, pre-treated, was supplied by Bio-adhesive Alliance Inc.

HTL experiments were performed at 330 □ in a 250 ml stainless steel bench top batch reactor (Parr Instrument Company, Moline, Ill.), equipped with magnetic stirrer, 4843-controller, and a jacketed heater. The working volume of the system is set to a maximum of 125 ml to facilitate the reactants expand during the heating process. The biorejuvenator was produced at 20% solid loading (25 grams dry weight) in all the HTL experiments. For instance, in the case of hybrid biorejuvenator scenario, algae-swine manure (50-50%, respectively), 12.5 grams of dry algae and 12.5 grams of swine manure were loaded into the reactor after evaluating the moisture content of each sample. The rest of the space was filled with distilled water (100 ml) to make a slurry of the desired solid loading. Once the experiments were done, the reactor was cooled to room temperature, degassed and the products were separated using dichloromethane as the non-polar solvent. The solvent was then recovered using a vacuum evaporator to obtain the biorejuvenator. The biorejuvenator obtained was stored under 4 □ to avoid oxidation and evaporation before analyzed by various tests.

Preparation of Aged and Rejuvenated Bitumen.

The bitumen used in this project was a Superpave PG 64-22, which is one of the most commonly used grades of bitumens across the US. Virgin bitumen was aged in a lab using a two-step aging process including short-term aging and long-term aging to simulate real aging process in the field. Short-term aging was performed via a Rolling Thin Film Oven (RTFO) which was done according to ASTM D2872 followed by a pressure aging vessel (PAV) based on ASTM D6521 standard, to simulate long term aging. The extended aging (total of 40 hours), is referred to as 2PAV. To prepare the samples, 10% (by weight of bitumen) of each biorejuvenator was hand blended into aged bitumen at 135° C. for 5 minutes on a hot plate. The scenarios are referred to by the percentage of each biorejuvenator. The samples studied are listed in Table 1.

TABLE 1
Biorejuvenator samples

| | | Biorejuvenator feedstock |
|---|---|---|
| | | composition based on weight |
| Sample | Biorejuvenator amount | percentage of solid material |
| Aged bitumen | NA | NA |
| (2PAV) | | |
| 2PAV + (0A:1S) | 10% of original bitumen amount | 0% Algae + 100% Swine manure |
| 2PAV + (1A:4S) | 10% of original bitumen amount | 20% Algae + 80% Swine manure |
| 2PAV + (1A:1S) | 10% of original bitumen amount | 50% Algae + 50% Swine manure |
| 2PAV + (4A:1S) | 10% of original bitumen amount | 80% Algae + 20% Swine manure |
| 2PAV + (1A:0S) | 10% of original bitumen amount | 100% Algae + 0% Swine manure |

### Experiments

Dynamic Shear Rheometer (DSR).

According to ASTMD7175-15, the elastic and viscous behavior of all samples were measured using Anton Paar Modular Compact Rheometer MCR 302 at 10 frequency intervals between 0.1 to 100 rad/s and at a fixed temperature (25° C.). An 8 mm spindle was utilized. Using the corresponding elastic (G′) and viscous (G″) moduli results, the crossover frequency and modulus were determined. Crossover frequency is the point where loss modules and elastic modulus are equal, and it is known as a fundamental property of bitumen. It has been used as an indicator to track extent of aging and rejuvenation.

Thin-Layer Chromatography with Flame Ionization Detection (TLC-FID).

The fractional composition of the aged bitumen modified with biomass was investigated using an Iatroscan MK-6s model TLC-FID analyzer. The hydrogen flow rate and air flow rate were set to 160 mL/min and 2 L/min, respectively. n-Heptane insoluble part, the asphaltene content, was separated and determined following the (ASTM, 2007) standard. Later, 20 μg of n-Heptane soluble (maltene), was spotted on the chromrods; Pentane, Toluene, and Chloroform solutions were used for solvent development. In a pentane tank, the chromrods were developed for 35-40 minutes and dried in the air for 2-5 minutes. The dried chromrods were then transferred into the second developing chamber filled with a 9:1 ratio of Toluene to Chloroform solution for 9 minutes. The rods were dried in the oven at 85° C., and the prepared specimen was scanned for 30 s utilizing an Iatroscan with FID detector.

Gas Chromatography-Mass Spectroscopy.

The biorejuvenator samples were analyzed using a Gas Chromatography Mass Spectrometry (GC-MS) for chemical and molecular composition. The biorejuvenators were dissolved in dichloromethane (DCM) and were filtered through 0.2 μm PTFE filter prior to injection into the GC column. ADB-5 column (30 m×250 μm×0.25 μm) was used to separate molecules based on molecular weight. The carrier gas (helium) was maintained at 1 ml/min throughout the analysis. The samples were diluted 10 fold before 1 μl was injected into the column in split less mode. The inlet temperature was maintained at 280° C., transfer line temperature at 250° C., and source temperature at 230° C. The chromatogram and the major peaks were processed and integrated using ChemStation and matched to NIST17 database.

### Molecular Dynamics

Molecular dynamics simulation was performed on a system at equilibrium state comprised of oxidized asphaltene molecules presented aged bitumen and heptane as a solvent medium, using Large-scale Atomic and Molecular Massively Parallel (LAMMPS) source code implemented in a MedeA® environment version 2.2. Interactions of molecules in biorejuvenator from co-liquefied process of balanced feedstock and oxidized asphaltene molecules were investigated to assess the effect of biorejuvenator molecules on self-interaction of asphaltene molecules. For this purpose, biorejuvenator molecules were introduced to the system of oxidized asphaltene after equilibration in heptane solvent.

The model was built in the MedeA® environment using the molecular builder, which allows an interactive, step-by-step construction of polyaromatic units with attached aliphatic chains and pyrrole rings. PCFF+ force field, which is an extension of the PCFF force field, was used. Force field refers to the functional form of parameters used to calculate the potential and kinetic energy of the system of atoms and molecules. PCFF+ is an all-atom forcefield designed to provide accuracy on hydrocarbon and liquid modeling from ab initio simulations. This forcefield includes a Lenard-Jones 9-6 potential for intermolecular and intramolecular interactions and specific stretching, bending, and torsion terms to involve 1-2, 1-3, and 1-4 interactions.

The simulation includes two subsequent LAMMPS stages starting with energy minimization using conjugate gradients method at a constant volume with a low average density to avoid molecular overlaps. The first stage started with an NVT (constant number of atoms, volume, and temperature) at a high temperature (800K) for 100 ps followed by an NPT (constant number of atoms, pressure, and temperature) at pressure of 200 atm and temperature of 800 K for 500 ps to shake the system and prevent its trapping at a local minimum energy state. The second stage of the two-stage LAMMPS was started with an NVT ensemble with a temperature of 350 K (76.85° C.) for 2 ns to reach an equilibrium with no pressure on the system followed by an NPT ensemble with a temperature of 350 K and a pressure of 1 atm for 20 ns. During all the stages of simulation a Nose-Hoover thermostat and barostat was utilized and the time step was set to 1 fs (10-15 s). The short-range interactions were calculated directly while long-range interactions were measured with the particle-particle-particle-mesh (PPPM) method. Non-bonded terms were calculated with a simple cutoff of 9.5 Å. The average temperature and pressure during NPT simulations was checked to ensure the system was in equilibrium.

After equilibration of oxidized asphaltenes in heptane, 10 wt % of selected biorejuvenator molecules were added to the system with respect to asphaltene fraction mass. Afterwards, the simulation was continued for another 20 ns to investigate the effect of biorejuvenator molecules on self-assembled stacks of oxidized asphaltenes. The average pressure and temperature were monitored during the simulation to ensure the system was in equilibrium. During the simulation, the coordinates for center of mass of asphaltene molecules were recorded for aggregation study, and the radial distribution function results were calculated for the most centered carbon atom of oxidized asphaltene molecules using “compute rdf” command.

Methods of Analysis.

To investigate the effect of rejuvenator's molecules on the self-assembled oxidized asphaltene molecules, the average aggregation number of oxidized asphaltene molecules in presence of each molecule was calculated. The average aggregation number (gz) was determined using Eq 1:

$${g}_{z} = \frac{{\sum }_{i} {n}_{i} {g}_{i}^{3}}{{\sum }_{i} {n}_{i} {g}_{i}^{2}} \qquad ( 1 )$$

where nᵢ is the number of aggregates containing gᵢ monomers.

The radial distribution function (g(r)) was calculated for oxidized asphaltene molecules before and after introduction of biorejuvenator molecules. The results of radial distribution function represent the most probable separation distance of oxidized asphaltene molecules which can be a measure of strength of asphaltenes self-interaction. RDF allows visualization of the degree of separation between a group of atoms, which in this study is a subset comprised of most centered atom of oxidized asphaltene molecules. g(r) is calculated using Equation 2:

$$g ( r ) = {lim}_{dr \to 0} \frac{V}{N ( N - 1 ) 4 {π r}^{2} dr} {\sum }_{i}^{N} {\sum }_{j \neq 1}^{N} δ ( r - {r}_{ij} ) \qquad ( 2 )$$

where V is the volume, N is the number of atoms included in the calculation, δ is the Kronecker delta function and rᵢⱼ is the distance between the two atoms.

### Results

Structure of Oxidized Asphaltene and Selected Biorejuvenator Molecules.

The selected molecules for this study are listed in Table 2. These molecules were identified using GC-MS on biorejuvenator produced in co-liquefied process of balanced feedstock containing a 50-50 ratio of swine manure and algae by weight. It should be noted that changing the ratio of the two bio-masses mainly changes the concentration of each of the identified molecules without altering type of molecules. The oxidized asphaltene molecule was a continental structure asphaltene with three carbonyl groups containing a core of poly-aromatic ring.

TABLE 2
Molecules found in biorejuvenator from co-liquefied
process of algae and swine manure

| Molecule name | Molecular formula |
|---|---|
| Phenol | C₆H₅OH |
| Butylpiperidine | C₉H₁₉N |
| Methylpyrrolidone | C₅H₉NO |
| Harmane | C₁₂H₁₀N₂ |
| Mesitonitrile | C₁₀H₁₁N |
| 3,7,1 1,15-Tetramethyl-2- | C₂₀H₄₀O |
| hexadecen-1-OL | |
| (Tetramethylhexadec) | |
| Myristamide | C₁₄H₂₉NO |
| Selected oxidized asphaltene | C₆₆H₇₅NO₃ |
| containing three carbonyl | |
| groups | |

Crossover Modulus and Frequency.

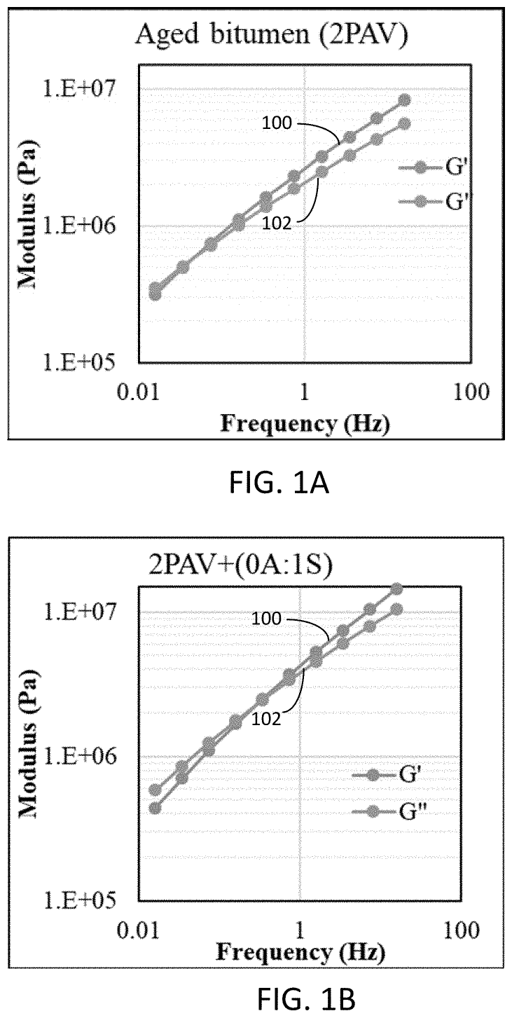

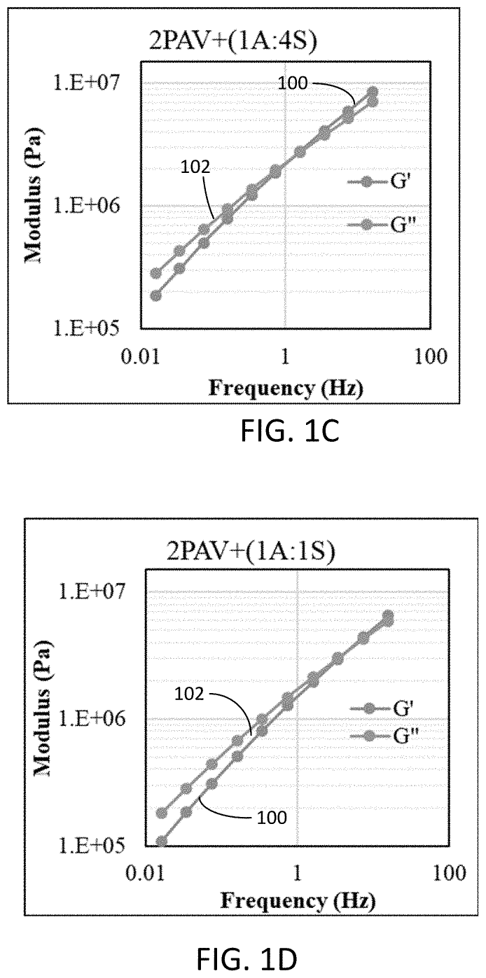

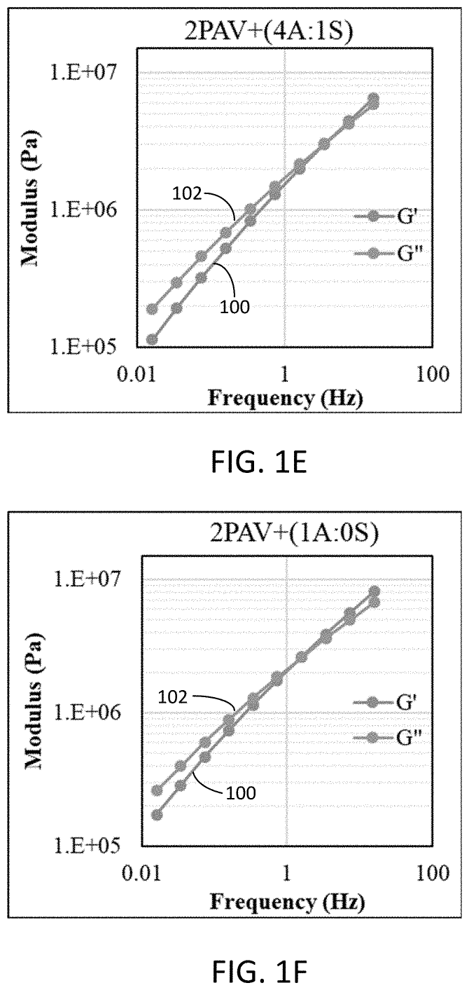

Using dynamic shear rheometer, the storage modulus and loss modulus of different samples at 25° C. were measured. FIGS. 1A-1F show storage modulus (G′) and loss modulus (G″) in plots 100 and 102, respectively, for aged asphalt before and after introducing biorejuvenators made from different ratio of algae and swine manure. The intercept of loss and storage modulus is known as crossover modulus, which is the modulus at tan δ=1 where viscous and elastic modulus are equal. The crossover modulus has been shown to have a strong correlation with aggregation of asphaltenes after aging, where the crossover modulus shifts to lower values.

Table 3 lists the difference between crossover modulus (Pa) (Δ crossover modulus) and crossover frequency (Hz) (Δ crossover frequency) for aged bitumen before and after introducing biorejuvenators made from different ratios of algae and swine manure. For all the rejuvenated samples, both the Δ crossover modulus and Δ crossover frequency showed positive values, suggesting that all biorejuvenators were able to increase the crossover modulus and crossover frequency values. A higher Δ crossover modulus and crossover frequency value shows a more efficient rejuvenation for the same aged bitumen. Here, the largest values for both crossover modulus and frequency value were found for an aged sample doped with 4A:1S (80% algae+20% swine manure) co-liquefied biorejuvenator. Other combinations of algae and swine manure co-liquefied samples were less effective in enhancing the Δ crossover modulus and Δ crossover frequency. Crossover modulus has been shown to have a strong relationship with polydispersity index (PDI) of bitumen. PDI is related to the ratio between the weight average molecular weight (Mw) and the number average molecular weight (Mn). The PDI of bitumen changes after aging as the average molecular weight increases. This is mainly attributed to the increase in polar fractions of bitumen, causing them to self-aggregate. This phenomenon can further associate to well-documented decrease of crossover modulus which is observed when bitumen is aged.

TABLE 3
Difference in crossover modulus and
crossover frequency

| | Δ Crossover | Δ Crossover |
|---|---|---|
| Sample | Modulus | Frequency |
| 2PAV + (0A:1S) | 1.99E + 6 | 0.31 |
| 2PAV + (1A:45) | 2.27E + 6 | 1.56 |
| 2PAV + (1A:1S) | 2.50E + 6 | 3.39 |
| 2PAV + (4A:1S) | 3.83E + 6 | 7.35 |
| 2PAV + (1A:0S) | 2.13E + 6 | 1.56 |

Thin-Layer Chromatography with Flame Ionization Detection (TLC-FID).

Saturate, aromatic, resin, and asphaltene portions of bitumen (SARA) was measured following the described TLC-FID method. Table 4 lists the SARA fractions of unaged bitumen, 2PAV aged bitumen, and aged bitumen doped with various biorejuvenators. After aging, the asphaltene content (insoluble fraction in heptane) increased from nearly 16% to 28%, while the aromatic content decreased from 24% to 15%. The rejuvenator produced from 80% algae and 20% swine manure reduced the asphaltene content of aged asphalt by 21% to be closer to that of the unaged asphalt, which was more effective than others. This can be due to combination of light components and fused aromatics of the other rejuvenators. Table 4 shows SARA fractions of isolated biorejuvenators.

TABLE 3
SARA fractions of unaged, aged, and aged bitumen
modified with biorejuvenators

| | Asphaltenes | Resins | Aromatics | Saturates |
|---|---|---|---|---|
| Sample | (%) | (%) | (%) | (%) |
| Unaged bitumen | 16.12 | 47.85 | 23.63 | 12.40 |
| Aged bitumen | 28.41 | 44.89 | 15.12 | 11.58 |
| (2PAV) | | | | |
| 2PAV + (0A:1S) | 29.51 | 48.38 | 12.77 | 9.35 |
| 2PAV + (1A:4S) | 24.21 | 51.10 | 15.62 | 9.07 |
| 2PAV + (1A:1S) | 30.08 | 41.88 | 15.10 | 12.93 |
| 2PAV + (4A:1S) | 22.47 | 51.44 | 16.39 | 9.70 |
| 2PAV + (1A:0S) | 26.60 | 48.39 | 12.19 | 12.09 |

TABLE 4
SARA fractions of isolated biorejuvenators

| | Asphaltenes | Resins | Aromatics | Saturates |
|---|---|---|---|---|
| Sample | (%) | (%) | (%) | (%) |
| 2PAV + (0A:1S) | 23.76 | 71.24 | 3.06 | 1.93 |
| 2PAV + (1A:0S) | 1.13 | 83.48 | 15.37 | 0 |

It can be observed that after aging, the asphaltene content (insoluble fraction in heptane) increased significantly from nearly 16% to 28%, while the aromatic content decreased from 24% to 15%. The co-liquefied rejuvenator shows slightly higher amount of asphaltene than aged binder. It should be noted that TLC-FID results are based on solubility of compounds in heptane and other solvents. Whatever that is insoluble in heptane, falls into asphaltene category. This change in asphaltene fraction of co-liquefied rejuvenator can be due to increase of organic acid part of the final product. The isolated rejuvenators (Table 4) helps to decouple the effect of each rejuvenator on changes in SARA fractions of rejuvenated bitumen samples. The results show that both rejuvenators are rich in resin type molecules. These resins may precipitate in heptane giving rise to asphaltene portion. However, they are structurally very different and can be effective in peptizing bitumen asphaltene. Considering that in bitumen modified with the co-liquefied rejuvenator, the number of aromatics increased more significantly compared to those modified with rejuvenators made from isolated bio-mass (algae or manure), it is hypothesized that co-liquefied rejuvenator is more effective in peptizing oxidized asphaltene molecules leading to lower size of nano-aggregates. This in turn can lead to a more efficient rejuvenation as evidenced in enhancement of rheological properties.

To evaluate the stability of the colloidal system of bitumen, colloidal stability index was calculated as shown in Eq. 3:

$$CI = \frac{( resins + aromatics )}{( asphaltenes + saturates )} \qquad ( 3 )$$

Table 5 lists the colloidal stability index (CI) calculated for the unaged, aged, and aged bitumen modified with biorejuvenators made from algae and swine manure. A higher index indicates better peptizing of asphaltene molecules by resins and aromatics. After aging, by converting aromatics to resins and resins to asphaltene due to oxidative aging, stability is disturbed, and the index decreased 40% from 2.5 for the unaged bitumen to 1.5 for the aged bitumen. Addition of biorejuvenator improved colloidal stability index for all the rejuvenated bitumen except 1A:1S, and the highest index was observed for sample modified with 4A:1S rejuvenator.

TABLE 5
Colloidal stability index (CI) for unaged,
aged, and aged bitumen modified with
biorejuvenators

| Sample | CI |
|---|---|
| Unaged bitumen | 2.51 |
| Aged bitumen (2PAV) | 1.50 |
| 2PAV + (0A:1S) | 1.57 |
| 2PAV + (1A:4S) | 2.00 |
| 2PAV + (1A:1S) | 1.32 |
| 2PAV + (4A:1S) | 2.11 |
| 2PAV + (1A:0S) | 1.57 |

Gas Chromatography-Mass Spectroscopy (GCMS).

The results of GC-MS for the biorejuvenator of scenario 1A:1S are listed in Table 6. The molecules found in GC-MS results further used for evaluation of their effect on the oxidized asphaltene deagglomeration. Although the Aged bitumen+(4A:1S) sample showed better results in rheological studies and chemical characterization, the identified molecules for rejuvenator product of mixed feedstock in HTL process does not depend on the amount of each feedstock. However, the concentration of each molecule is subject to change with change of percentage of each feedstock.

TABLE 6
GC-MS results for molecular components of 1A:1S biorejuvenator

| | Formula | | Percent |
|---|---|---|---|
| Substance Name | (DB) | Area | area |
| p-Cresol | C₇H₈O | 13373066 | 6% |
| Nonadecanamide | C₁₉H₃₉NO | 7837106 | 3% |
| 2-Pyrrolidinone, 1-methyl- | C₅H₉NO | 7696219 | 3% |
| Piperidine, 1-pentyl- | C₁₀H₂₁N | 7589471 | 3% |
| Phenol | C₆H₆O | 7298749 | 3% |
| 9H-Pyrido[3,4-b]indole, 1-methyl- | C₁₂H₁₀N₂ | 7288376 | 3% |
| 1-Ethyl-2-pyrrolidinone | C₆H₁₁NO | 6250022 | 3% |
| 3,7,11,15-Tetramethylhexadec- | C₂₀H₄₀ | 6238750 | 3% |
| 2-ene | | | |
| Phenol, 4-ethyl- | C₈H₁₀O | 5313636 | 2% |
| Piperidine, 1-butyl- | C₉H₁₉N | 5186418 | 2% |
| Myristamide, N-methyl- | C₁₅H₃₁NO | 4627090 | 2% |
| 3,7,11,15- | C₂₀H₄₀ | 3939977 | 2% |
| Tetramethylhexadec-2-ene | | | |
| Benzonitrile, 2,4,6-trimethyl- | C₁₀H₁₁N | 3310139 | 1% |

Table 7 lists the chemical composition of biorejuvenators produced from different combinations of algae and swine manure feedstock.

TABLE 7
Chemical composition of various biorejuvenators

| | | Org. | | | Fatty | Org. |
|---|---|---|---|---|---|---|
| | Ketones | Arom. | Lipids | Hydrocarbons | Amides | Acids |
| Sample | (%) | (%) | (%) | (%) | (%) | (%) |
| 2PAV + | 0.70 | 0.70 | 60.90 | 1.40 | 6.50 | 29.70 |
| (0A:1S) | | | | | | |
| 2PAV + | 0 | 14.60 | 0 | 0 | 25.6 | 59.8 |
| (1A:4S) | | | | | | |
| 2PAV + | 0 | 7.2 | 0 | 0 | 0 | 92.8 |
| (1A:1S) | | | | | | |
| 2PAV + | 0 | 17.48 | 0 | 2.3 | 33.10 | 47.2 |
| (4A:1S) | | | | | | |
| 2PAV + | 5.10 | 16.8 | 0 | 58.4 | 0 | 19.7 |
| (1A:0S) | | | | | | |

### Molecular Dynamics Results

Structure of Oxidized Asphaltene and Selected Biorejuvenator Molecules.

The selected molecules for this study are listed in Table 2. These molecules were identified by GC-MS analysis of the biorejuvenator produced from co-liquefaction of a balanced feedstock containing a 50-50 wt ratio of swine manure and algae. The criteria for selection was for the molecule to contain nitrogen and to have a straight-chain or aromatic structures. The oxidized asphaltene molecule used in this study was a continental structure asphaltene with three carbonyl groups containing a core of poly-aromatic ring. The concentration for MD simulation was set to be 10% of initial mass of oxidized asphaltene molecule fraction.

Average aggregation number were calculated using Equation 1 for ensembles including isolated oxidized asphaltene and oxidized asphaltene with 10 wt % of rejuvenator molecules relative to asphaltene fraction mass. To be able to interpret the results, a density chart was plotted to provide the number of data points in each range of aggregation number. The higher number of data points at lower range of aggregation number illustrates a better performance regarding peptizing of oxidized asphaltene molecules. The results show that methylpyrrolidone, myristamide and butylpiperidine have the potential to reduce the size of oxidized asphaltene nano-aggregates as they have higher density of data points at lower range of aggregation number.

To better understand the effect of each rejuvenator in intermolecular interaction of oxidized asphaltenes, radial distribution function (RDF) was calculated for the most centered carbon atom of oxidized asphaltene molecules as a measure of degree of interactions between asphaltene molecules. Higher distance for RDF peaks shows that the interaction is weakened as the molecules are more likely to have a larger stacking distance. The same conclusion can be derived for lower intensity RDF peaks, which means it's less probable for molecules to maintain a particular distance from each other.

The oxidized asphaltene molecules in heptane have two distinct RDF peaks related to shape of stacking, which can be parallel and displaced parallel or T-shaped stacking. The first peak (ranges from 4 to 6 Angstroms) is representative of parallel stacking while the longer distance peak (ranging from 7 to 8.5 Angstrom) is due to T-shaped stacking of asphaltene molecules. RDF is a measure to show the density of molecules from a reference point. Here, the reference point of RDF calculations is the most centered carbon atom of oxidized asphaltene molecules. The RDF results show that butylpiperidine, myristamide, and tetramethylhexadec have the potential to reduce RDF peaks compared to pure oxidized asphaltene, suggesting these molecules can promote deagglomeration of oxidized asphaltene nano-aggregates. RDF results illustrate that tetramethyl hexadec shows reduction in RDF peaks. However, although this molecule can weaken the oxidized asphaltene interactions, its global effect can increase agglomeration of oxidized asphaltene or have little effect on nano-particles size reduction. Furthermore, the results of RDF show all rejuvenator molecules were able to reduce the second peak of RDF related to displaced parallel stacking and T-shaped stacking.

To better illustrate the peptizing effect of rejuvenator, snapshots of simulations illustrating the mechanism of deagglomeration of myristamide were taken. The snapshots illustrate the three-step mechanism of oxidized asphaltene deagglomeration as a result of interaction with biorejuvenator molecules. As understood from the snapshots, rejuvenator molecules approach nanoparticles of oxidized asphaltene, then penetrate and deagglomerate the oxidized asphaltene nanoaggregate.

Additional information is found in Samieadel et al., Construction and Building Materials 262 (2020) 120090, Pahlavan et al., ACS Sustainable Chem. Eng. 2020, 8, 7656-7667, and Pahlavan et al., ACS Sustainable Chem. Eng. 2019, 7, 18, 15514-15525, all of which are incorporated by reference herein in their entirety.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A biorejuvenator comprising:
a bio-oil formed from a mixture comprising:
a first biomass component; and
a second biomass component,
wherein a nitrogen content of the first biomass component exceeds a nitrogen content of the second biomass component, and a lipid content of the second biomass component exceeds a lipid content of the first biomass component.

2. The biorejuvenator of claim 1, wherein the first biomass component is liquefied, and the second biomass component is liquefied.

3. The biorejuvenator of claim 1, wherein the first biomass component and the second biomass component are co-liquefied.

4. The biorejuvenator of claim 1, wherein a dry weight ratio of the first biomass component to the second biomass component is in a range of about 6:1 to about 2:1.

5. The biorejuvenator of claim 4, wherein the dry weight ratio of the first biomass component to the second biomass component is about 4:1.

6. The biorejuvenator of claim 1, wherein the first biomass component comprises algae and the second biomass component comprises swine manure.

7. An asphalt composition comprising:
asphalt; and
the biorejuvenator of claim 1.

8. The asphalt composition of claim 7, wherein a weight ratio of the asphalt to the biorejuvenator is in a range of about 5:1 to about 20:1.

9. The asphalt composition of claim 7, wherein the asphalt is reclaimed asphalt pavement.

10. A coated asphalt comprising:
an asphalt substrate; and
a coating of the biorejuvenator of claim 1 on the asphalt substrate.

11. A method of preparing a biorejuvenator, the method comprising:
combining a first biomass component and a second biomass component, wherein a nitrogen content of the first biomass component exceeds a nitrogen content of the second biomass component, and a lipid content of the second biomass component exceeds a lipid content of the first biomass component; and
co-liquefying the first biomass component and the second biomass component to yield the biorejuvenator.

12. The method of claim 11, wherein a dry weight ratio of the first biomass component to the second biomass component is in a range of about 6:1 to about 2:1.

13. The method of claim 12, wherein a dry weight ratio of the first biomass component to the second biomass component is about 4:1.

14. The method of claim 11, wherein the first biomass component comprises algae.

15. The method of claim 11, wherein the second biomass component comprises swine manure.

16. The method of claim 11, wherein co-liquefying comprises hydrothermally liquefying.

17. The method of claim 11, further comprising combining the biorejuvenator with asphalt.

18. The method of claim 17, wherein the asphalt is reclaimed asphalt pavement.

19. The method of claim 11, further comprising coating an asphalt surface with the biorejuvenator.

20. The method of claim 11, wherein the biorejuvenator is a bio-oil.
